(19) United States
(12) Patent Application Publication
(10) Pub. No.: US 2005/0220227 A1
(43) Pub. Date: Oct. 6, 2005

(54) Method and apparatus to detect modulation scheme

(76) Inventor: Eyal Krupka, Ramat Gan (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/813,050

(22) Filed: Mar. 31, 2004

(51) Int. Cl. H04B 7/216

(52) U.S. Cl. 375/340

(57) ABSTRACT

Briefly, a method and apparatus that may detect a property received signal. The property may be a modulation scheme and/or training sequence and the detection of the property may be done by estimating energy of one or more channel taps outside the range of a channel of the received signal.

### BACKGROUND OF THE INVENTION

Wireless communication systems such as cellular communication systems may include a plurality of modulation schemes which may be used with different cellular standards such as, for example GSM, GPRS, EDGE and the like. According to EDGE standard a block of data may be transmitted in either 8PSK or GMSK modulation. A sequence of 26 known symbols may be used to detect the modulation.

The algorithms to detect the modulation schemes of data block may be performed by a processor, for example a digital signal processor (DSP). The complexity of those algorithms may be high, thus, the processor may perform a relatively high number of computation operations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is an illustration of a portion of a wireless communication system according to an exemplary embodiment of the present invention;

FIG. 2 is a block diagram of a mobile station according to some exemplary embodiments of the present invention; and

FIG. 3 is a flowchart of a method to detect a modulation scheme according to exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like. For example, “plurality of mobile stations” describes two or more mobile stations.

It should be understood that the present invention may be used in a variety of applications. Although the present invention is not limited in this respect, the circuits and techniques disclosed herein may be used in many apparatuses such as transmitters of a radio system. Transmitters intended to be included within the scope of the present invention include, by way of example only, wireless local area network (WLAN) transmitters, two-way radio transmitters, digital system transmitters, analog system transmitters, cellular radiotelephone transmitters and the like.

Types of cellular radiotelephone systems intended to be within the scope of the present invention include, although are not limited to, Code Division Multiple Access (CDMA) and WCDMA cellular radiotelephone portable devices for transmitting and receiving spread spectrum signals, Global System for Mobile communication (GSM) cellular radiotelephone, Time Division Multiple Access (TDMA), Extended-TDMA (E-TDMA), General Packet Radio Service (GPRS), Extended GPRS, and the like.

The term “plurality” may be used throughout the specification to describe two or more components, devices, elements, parameters and the like. For example, “plurality of mobile stations” describes two or more mobile stations. In addition, it should be known to one skilled in the art that the term “a portable communication device” may refer to, but is not limited to, a mobile station, a portable radiotelephone device, a cell-phone, a cellular device, personal computer, Personal Digital Assistant (PDA), user equipment, and the like.

Some embodiments of the invention may be implemented, for example, using a machine-readable medium or article which may store an instruction or a set of instructions that, if executed by a machine (for example, by stations of wire less communication system and/or by other suitable machines), cause the machine to perform a method and/or operations in accordance with embodiments of the invention. Such machines may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

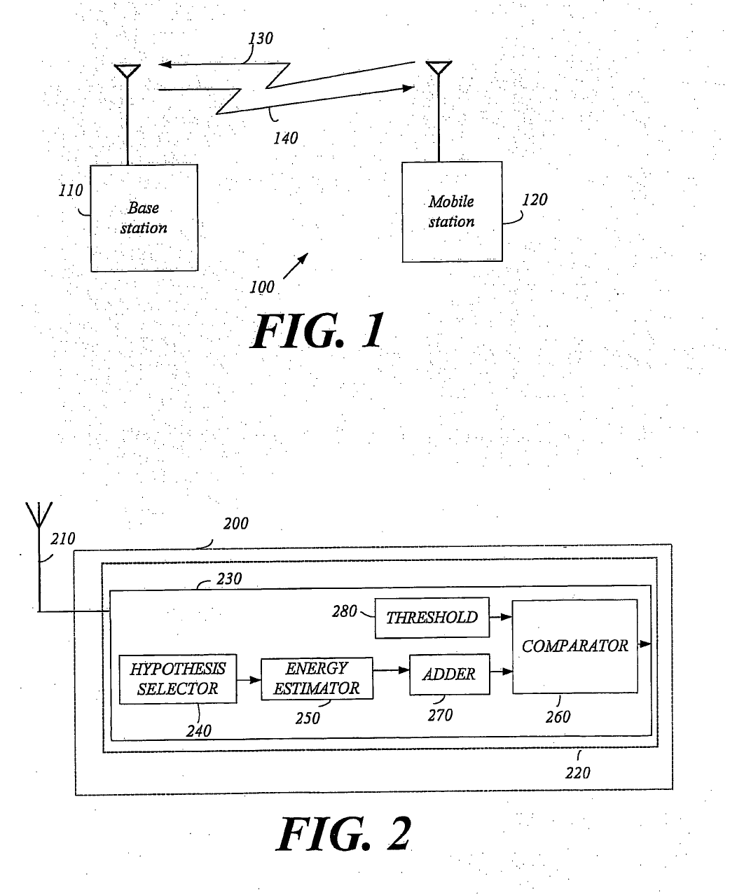

Turning to FIG. 1, a wireless communication system such as, for example, a cellular system 100 in accordance with an exemplary embodiment of the invention is shown. Although the scope of the present invention is not limited in this respect, cellular system 100 may include a base station 110 a mobile station 120, an uplink 130 and a downlink 140. Uplink 130 and downlink 140 may include one or more channels. In accordance with embodiments of the invention, a channel may be a physical transfer medium that may be used to transfer signals that may be modulated by one or more modulation scheme. Furthermore, an effective channel may be a combination of the physical transfer medium, components of the transmitter and/or receiver and may include channel taps (for example, symbols). According to embodiments of the invention the effective channel may be estimated and/or measured by a channel time span. In embodiments of the invention, the effective channel time span may not exceed a certain number of symbols, for example seven symbols. In addition the effective channel time span may not exceed a certain delay spread, if desired.

Although the scope of the present invention is not limited in this respect, mobile station 120 may detect the modulation scheme of the received signal by estimating energy of the effective channel tap which is outside of the effective channel time span, for example, the 10^{th} channel tap, if desired. In embodiments of the invention, the estimated energy of the channel tap of the 10^{th} and/or the 11^{th} channel tap may be expected to be around zero. The received signal may be demodulated by a selected modulation scheme and if, for example, the energy of the 10^{th} channel tap is below a predefined threshold (e.g. a proximally zero) then the selected modulation scheme may be assumed as the detected modulation scheme. In other embodiments of the invention, the energy of the estimated tap, for example channel tap 10, 11, 12, or the like, may be above the threshold. In those embodiments, the hypotheses may be considered as failing to detect the modulation scheme of the received signal, although the scope of the present invention is not limited in this respect.

Turning to FIG. 2, a block diagram of a mobile station 200 according to an exemplary embodiment of the invention is shown. Although the scope of the present invention is not limited in this respect, mobile station 200 may include an antenna 210 and a receiver 220. In embodiments of the invention, receiver 220 may include a detector 230. In some embodiments of the invention, detector 230 may include a hypothesis selector 240, an energy estimator 250, a comparator 260, an adder 270 and a threshold 280.

Although the scope of the present invention is not limited in this respect antenna 210 may receive a signal that may include one or more data blocks. In some embodiments ofthe invention, antenna 210 may include an internal antenna, or an omni-directional antenna, or a monopole antenna, or a-dipole antenna, or an end fed antenna or a circularly polarized antenna, or a micro-strip antenna, or a diversity antenna, or a dual antenna, or an antenna array or the like.

Although the scope of the present invention is not limited in this respect, detector 230 may detect a modulation scheme of the received signal by estimating energy of an effective channel tap which is outside of an effective channel time span. In embodiments of the invention, the received signal may include data block that may be used to estimate the channel information, such as, for example, a training sequence, a pilot data, and the like.

Although the scope of the present invention is not limited in this respect, energy estimator 250 may use any of a variety of different effective channel estimation techniques including, for example, a least squares technique, a linear minimum mean square error (LMMSE) technique, and others. In at least one embodiment, the effective channel estimate may be determined using the following least squares technique:
x=Hθ+w
\hat{θ}=(H^{H}H)⁻¹H^{H}x
h=\hat{θ}
where x may be the received signal at known and/or desired training sequence, H may be a known effective channel observation matrix, the row of H may contain modulated (transmitted) symbols in the training sequence, θ may be the unknown effective channel, w may be the noise at the receiver, \hat{θ} may be the estimator of θ, H^{H} may be the hermitian (transpose & complex conjugate) of H, and h may be the estimated effective channel. Furthermore, according to embodiments of the invention, H may be dependent on the hypothesis such as, for example modulation hypothesis and/or training sequence hypothesis. Other channel estimation techniques may also be used with embodiments of the invention.

Although the scope of the present invention is not limited in this respect, a channel tap may be represent by a row (H^{H}H)⁻¹H^{H} of the effective channel metric H, if desired. For example, energy estimator 250 may estimate the 10^{th} channel tap that may be the 10^{th} row of matrix Q (e.g. Q=(H^{H}H)⁻¹H^{H}) by performing a calculation of h₁₀=Q₁₀x.

Although the scope of the present invention is not limited in this respect, in this exemplary embodiment of the invention, hypothesis selector 240 may select a modulation hypothesis, for example, 8PSK, GMSK and the like. Energy estimator 250 may estimate the energy of a channel tap for example the 10^{th} tap, 11^{th}, 12^{th} etc., that may be outside the effective channel time span according to the selected modulation hypothesis. Energy estimator 250 may provide estimated energy value to comparator 260. Comparator 260 may compare a value of the estimated energy to an expected predetermined threshold that may be stored in threshold 280, if desired.

In some embodiments of the invention, energy estimator 250 may estimate the energy of two or more channel taps that may be outside the effective channel time span, for example the 10^{th} channel tap, 11^{th} channel tap, etc. In those embodiments, adder 270 may sum the energy of the two or more effective channel taps and may provide a sum of estimated energy values to comparator 260. Comparator 260 may compare the sum of estimated energy values to an expected predetermined threshold that may be stored in threshold 280, if desired.

Although the scope of the present invention is not limited in this respect, the detection of the modulation scheme according to the selected modulation hypothesis may be assumed successful if the energy or the sum of energies of the effective channel taps may be below or similar to the predetermined threshold.

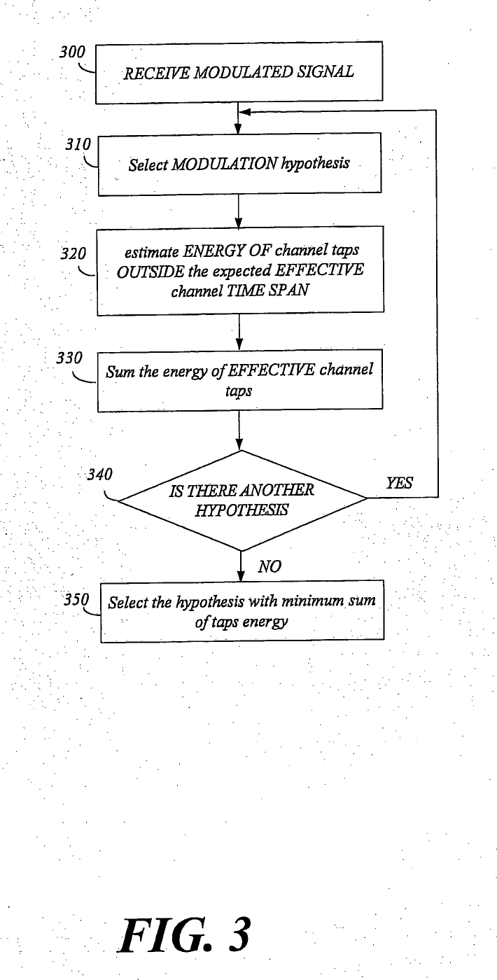

Turning to FIG. 3 a flowchart of a method to detect a modulation scheme of a received signal according to exemplary embodiments of the invention is shown. Although the scope of the present invention is not limited in this respect, the method may start with a receiver and may receive a modulated received signal (text box 300). In some embodiments of the invention, the received signal may include data slots. In those embodiments the receiver may decode the data of the slot, if desired.

In embodiments of the invention, hypothesis selector 240 may select a modulation hypothesis to be use to detect the modulation scheme (text box 310). In other embodiments of the invention, the method may be used to detect, for example, a sequence of symbols. In those embodiments of the invention, hypothesis selector 240 may select the most probable hypothesis, for example, a sequence of symbols hypothesis and/or modulation hypothesis, if desired. For example, mobile station 200 may be an EDGE cellphone. Thus, according to EDGE modulation schemes there may be 16 hypothesis combinations of two modulation types and eight possible hypothesis combinations of two training sequences.

Although the scope of the present invention is not limited in this respect, energy estimator 250 may estimate the energy of channels taps outside the effective channel time span (text box 320). For example, the expected channel time span may include nine effective channel taps thus, energy estimator 250 may estimate the 10^{th}, 11^{th}, 12^{th}, etc. effective channel taps. The expected effective channel span may be determined by the type of the wireless communication system. For example, due to physical considerations, in GSM/GPRS cellular communication system the expected effective channel time span may be six.

Although the scope of the present invention is not limited in this respect, adder 270 may sum the energy values of the effective channel taps (text box 330) that were estimated according to a first hypothesis. According to some embodiments of the invention, hypothesis selector 240 may select between two or more modulation hypothesis. The energy estimation of the effective channel taps may be repeated for the two or more hypotheses (text box 340). In those embodiments, the modulation hypothesis that may provide the minimum sum of energies of the effective channel taps may be detected as the modulation scheme of the received signal (text box 350). Thus, the receiver may demodulate the received signal according to the decoded modulation scheme.

Although the scope of the present invention is not limited in this respect, according to other embodiments of the invention, the sum of energies of the effective channel taps may be compared to a threshold. The modulation scheme may be detected if the energy of the effective channel taps are below the threshold. In some embodiments of the invention, if the modulation scheme has been detected, the other hypothesis may not be tested, although the scope of the present invention is not limited in this respect.

Although the scope of the present invention is not limited in this respect, it should be understood that the methods, apparatuses, and system that are described with embodiments of the invention are not limited to detecting modulation schemes and/or training sequences of received signals and may be used to detect other properties of the received signal.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
detecting a modulation scheme of a received signal by estimating an energy of an effective channel tap which is outside of an effective channel time span.

2. The method of claim 1, wherein detecting comprises:
selecting a modulation hypothesis;
estimating the energy of the effective channel tap according to the modulation hypothesis to provide an estimated energy value; and
comparing the estimated energy value to an expected predetermined threshold to provide a detection value.

3. The method of claim 2, comprising:
repeating the selecting and comparing if the detection value indicates a misdetection of the modulation scheme.

4. The method of claim 2, comprising:
stopping detection of the modulation scheme if the detection value indicates a detection of the modulation scheme.

5. The method of claim 1 wherein detecting comprises:
estimating an energy of two or more effective channel taps which are outside of the effective channel time span.

6. The method of claim 5, comprising:
selecting a modulation hypothesis;
summing estimated energy values of the two or more effective channel taps to provide a sum of estimated energy values; and
comparing a value of an energy of an effective channel tap according to the modulation hypothesis to the sum of estimated energy values to provide a detection value.
comparing a value of an energy of an effective channel tap according to the modulation hypothesis to the sum of estimated energy values to provide a detection value.

7. The method of claim 6, comprising:
repeating selecting and comparing if the detection value indicates a misdetection of the modulation scheme.

8. The method of claim 6, comprising:
stopping detection of the modulation scheme if the comparison value indicates a detection of the modulation scheme.

9. A method comprising:
detecting a training sequence of a received signal by estimating an energy of an effective channel tap which is outside of an effective channel time span.

10. The method of claim 9, wherein detecting comprises:
selecting a training sequence hypothesis;
estimating the energy of the effective channel tap according to the training sequence hypothesis to provide an estimated energy; and
comparing a value of the estimated energy to an expected predetermined threshold to provide a detection value.

11. The method of claim 10, comprising:
repeating selecting and comparing if the detection value indicates misdetection of the training sequence.

12. The method of claim 10, comprising:
stopping detection of the training sequence of the received signal if the detection value indicates detection of the training sequence.

13. The method of claim 9, comprising:
selecting a training sequence hypothesis;
summing estimated energy values of the two or more effective channel taps to provide a sum of estimated energy values; and
comparing a value of an energy of an effective channel tap according to the training sequence hypothesis to the sum of estimated energy values to provide a detection value.

14. The method of claim 9, comprising:
repeating selecting and comparing if the detection value indicates misdetection of the training sequence.

15. The method of claim 13, comprising:
stopping detection of the training sequence of the received signal if the detection value indicates detection of the training sequence.

16. An apparatus comprising:
a detector to detect a property of a received signal by estimating an energy of a channel tap which is outside of a channel range.

17. The apparatus of claim 16, wherein the property is a modulation scheme of the receive signal and the apparatus further comprising:
a hypothesis selector to select a modulation hypothesis;
an energy estimator to estimate an energy of a channel tap according to the modulation hypothesis to provide an estimated energy; and
a comparator to compare a value of the estimated energy to an expected predetermined threshold.

18. The apparatus of claim 16, comprising:
an adder to sum estimated energy values of two or more channel taps to provide a sum of estimated energy values.

19. The apparatus of claim 16, wherein the property is a training sequence of the receive signal and the apparatus further comprising:
a hypothesis selector to select a training sequence hypothesis;
an energy estimator to estimate an energy of a channel tap according to the training sequence hypothesis to provide estimated energy; and
a comparator to compare a value of the estimated energy to expected predetermined threshold.

20. A wireless communication device comprising:
an internal antenna to receive a signal;
a detector to detect a property of the received signal by estimating an energy of a channel tap which is outside of a channel range.

21. The wireless communication device of claim 20, wherein the property is a modulation scheme of the receive signal and the apparatus further comprising:
a hypothesis selector to select a modulation hypothesis;
an energy estimator to estimate an energy of a channel tap according to the modulation hypothesis to provide an estimated energy; and
a comparator to compare a value of the estimated energy to an expected predetermined threshold.

22. The wireless communication device of claim 20, comprising:
an adder to sum estimated energy values of two or more channel taps to provide a sum of estimated energy values.

23. The wireless communication device of claim 20, wherein the property is a training sequence of the received signal and the apparatus further comprising:
a hypothesis selector to select a training sequence hypothesis;
an energy estimator to estimate an energy of a channel tap according to the training sequence hypothesis to provide estimated energy; and
a comparator to compare a value of the estimated energy to expected predetermined threshold.

24. A wireless communication system comprising:
a wireless communication device includes a detector to detect a property of the received signal by estimating an energy of a channel tap which is outside of a channel range.

25. The wireless communication system of claim 24, wherein the property is a modulation scheme of the received signal and the apparatus further comprising:
a hypothesis selector to select a modulation hypothesis;
an energy estimator to estimate an energy of a channel tap according to the modulation hypothesis to provide an estimated energy; and
a comparator to compare a value of the estimated energy to an expected predetermined threshold.

26. The wireless communication system of claim 24, comprising:
an adder to sum estimated energy values of two or more channel taps to provide a sum of estimated energy values.

27. The wireless communication system of claim 24, wherein the property is a training sequence of the received signal and the apparatus further comprising:
a hypothesis selector to select a training sequence hypothesis;
an energy estimator to estimate an energy of a channel tap according to the training sequence hypothesis to provide estimated energy; and
a comparator to compare a value of the estimated energy to expected predetermined threshold.

28. An article comprising: a storage medium, having stored thereon instructions, that when executed, result in:
detecting a modulation scheme of a received signal by estimating an energy of an effective channel tap which is outside of an effective channel time span.

29. The article of claim 28, wherein the instructions, when executed, result in:
selecting a modulation hypothesis;
estimating the energy of the effective channel tap according to the modulation hypothesis to provide an estimated energy value; and
comparing the estimated energy value to an expected predetermined threshold to provide a detection value.

30. The article of claim 29, wherein the instructions, when executed, result in:
repeating the selecting and comparing if the detection value indicates a misdetection of the modulation scheme.

31. The article of claim 29, wherein the instructions, when executed, result in:
stopping detection of the modulation scheme if the detection value indicates a detection of the modulation scheme.

32. The article of claim 28, wherein the instructions, when executed, result in:
estimating an energy of two or more effective channel taps which are outside of the effective channel time span.

33. The article of claim 32, wherein the instructions, when executed, result in:
selecting a modulation hypothesis;
summing estimated energy values of the two or more effective channel taps to provide a sum of estimated energy values; and
comparing a value of an energy of an effective channel tap according to the modulation hypothesis to the sum of estimated energy values to provide a detection value.

34. The article of claim 33, wherein the instructions, when executed, result in:
repeating selecting and comparing if the detection value indicates a misdetection of the modulation scheme.

35. The article of claim 33, wherein the instructions, when executed, result in:
stopping detection of the modulation scheme if the comparison value indicates a detection of the modulation scheme.
